(19) United States
(12) Patent Application Publication
(10) Pub. No.: US 2017/0022109 A1
(43) Pub. Date: Jan. 26, 2017

(54) POLYPHOSPHORIC ACID RESISTANT HYDROGEN SULFIDE SCAVENGER FOR USE IN ASPHALT APPLICATIONS

(71) Applicant: BAKER HUGHES INCORPORATED, Houston, TX (US)

(72) Inventors: ROSS RIVERS POLAND, WHARTON, TX (US); PAUL BIGGERSTAFF, SUGAR LAND, TX (US); KYLE CATTANACH, HOUSTON, TX (US); TIMOTHY O'BRIEN, SUGAR LAND, TX (US); DONALD WOLFE, BADEN, PA (US); JERRY WEERS, RICHMOND, TX (US); MATTHEW BARNES, MISSOURI CITY, TX (US)

(73) Assignee: BAKER HUGHES INCORPORATED, Houston, TX (US)

(21) Appl. No.: 15/213,927

(22) Filed: Jul. 19, 2016

Related U.S. Application Data
(60) Provisional application No. 62/196,139, filed on Jul. 23, 2015.

(51) Int. Cl. C04B 26/26; C04B 22/16; C04B 24/04; C04B 22/00; C04B 22/06

(52) U.S. Cl. CPC C04B 26/26; C04B 22/00; C04B 22/06; C04B 24/04; C04B 22/165; C04B 2103/0068

(57) ABSTRACT

A method and composition for reducing hydrogen sulfide generated or emitted from an asphalt composition are disclosed. In certain aspects, a method for reducing hydrogen sulfide emissions from an asphalt composition is provided wherein an additive is mixed with the asphalt composition and the additive is a copper-based complex. The asphalt composition can include asphalt and an asphalt modifying acid. The copper-based complex can comprise copper carboxylate. The copper carboxylate can be an oil-soluble metal organic.

### CROSS REFERENCE TO RELATED APPLICATIONS

This application claims the benefit, and priority benefit, of U.S. Provisional Patent Application Ser. No. 62/196,139, filed Jul. 23, 2015, the disclosure and contents of which are incorporated by reference herein in their entirety.

### BACKGROUND

1. Field of the Invention

The presently disclosed subject matter relates generally to asphalt production, and in particular, to asphalt production employing chemical additives.

2. Description of the Related Art

Asphalt is a viscous substance derived from crude petroleum and used in paving and road construction materials or as roofing shingles. A common asphalt modifying agent is polyphosphoric acid (PPA). PPA can be added to asphalt compositions to increase the binder stiffness of the asphalt mix and to reduce the susceptibility of the asphalt binder to aging.

A rising concern in the asphalt industry is the generation of hydrogen sulfide (H₂S) caused by modification of asphalt using polyphosphoric acid. H₂S is toxic and corrosive, which are factors that make asphalt production more dangerous and costly. H₂S scavenging additives consisting of zinc-based compounds are frequently used to reduce H₂S content in asphalt. There is growing evidence; however, that use of PPA during asphalt production can reduce the effectiveness of these zinc-based, and other, H₂S scavengers.

There is a need for new scavengers that are resistant to the effects of PPA. Improvements in this field of technology are therefore desired.

### SUMMARY

In certain aspects, a method for reducing hydrogen sulfide emissions from an asphalt composition is provided wherein an additive is mixed with the asphalt composition and the additive is a copper-based complex. The asphalt composition can include asphalt and an asphalt modifying acid. The hydrogen sulfide can be one or more of latent hydrogen sulfide, hydrogen sulfide produced by cracking and hydrogen sulfide produced by regenerative processes caused by the asphalt modifying agent being added to the asphalt composition. The asphalt modifying acid can be polyphosphoric acid. The asphalt modifying acid can also be an inorganic acid. The inorganic acid can be phosphoric acid or a phosphonate derivative. The asphalt modifying acid can be a salt or organic ester of an inorganic acid. The salt can be sodium phosphate. The copper-based complex can include one or more components from the group consisting of copper carbonate, copper hydroxide and copper oxide. The copper-based complex can include copper carboxylate. The copper carboxylate can be an oil-soluble metal organic. The copper-based complex can be formed by reacting copper with an organic acid and diluting the resultant mixture with an organic solvent. The additive can include one or more components from the group consisting of zinc carboxylate, a dispersion of zinc particles, and an amine aldehyde condensate. The organic acid can be one or more from the group consisting of octanoic acid isomers (such as 2-ethylhexanoic acid), neodecanoic acid, naphthenic acid, isobutyric acid, and other oil soluble synthetic carboxylic acids.

In another aspect, a method for reducing hydrogen sulfide emissions from an asphalt composition is provided wherein an additive is mixed with the asphalt composition and the additive is an iron-based complex. The asphalt composition can include asphalt and an asphalt modifying acid. The hydrogen sulfide can be one or more of latent hydrogen sulfide, hydrogen sulfide produced by cracking and hydrogen sulfide produced by regenerative processes caused by the asphalt modifying agent being added to the asphalt composition. The asphalt modifying acid can be polyphosphoric acid. The asphalt modifying acid can be an inorganic acid. The inorganic acid can be phosphoric acid or a phosphonate derivative. The asphalt modifying acid can be a salt or organic ester of an inorganic acid. The salt can be sodium phosphate. The iron-based complex can include one or more components from the group consisting of iron carbonate, iron hydroxide and iron oxide. The iron-based complex can include iron carboxylate. The iron carboxylate can be an oil-soluble metal organic. The iron-based complex can be formed by reacting iron with an organic acid and diluting the organic acid with an organic solvent. The additive can further include one or more components from the group consisting of zinc carboxylate, a dispersion of zinc particles, and an amine aldehyde condensate. The organic acid can be one or more from the group consisting of octanoic acid isomers (such as 2-ethylhexanoic acid), neodecanoic acid, naphthenic acid, isobutyric acid, or other synthetic carboxylic acids.

In another aspect, a composition comprising an asphalt and an additive is provided wherein the additive includes a copper-based complex. The composition can further include an asphalt modifying agent. The hydrogen sulfide can be one or more of latent hydrogen sulfide, hydrogen sulfide produced by cracking and hydrogen sulfide produced by regenerative processes caused by the asphalt modifying agent being added to the composition. The asphalt modifying acid can be polyphosphoric acid. The asphalt modifying acid can also be an inorganic acid. The inorganic acid can be phosphoric acid or a phosphonate derivative. The asphalt modifying acid can be a salt or organic ester of an inorganic acid. The salt can be sodium phosphate. The copper-based complex can include one or more components from the group consisting of copper carbonate, copper hydroxide and copper oxide. The copper-based complex can include an oil soluble copper carboxylate.

In another aspect, a composition comprising an asphalt and an additive is provided wherein the additive includes an iron-based complex. The composition further includes an asphalt modifying agent. The hydrogen sulfide can be one or more of latent hydrogen sulfide, hydrogen sulfide produced by cracking and hydrogen sulfide produced by regenerative processes caused by the asphalt modifying agent being added to the composition. The asphalt modifying acid can be polyphosphoric acid. The asphalt modifying acid can be an inorganic acid. The inorganic acid can be phosphoric acid or a phosphonate derivative. The asphalt modifying acid can be a salt or organic ester of an inorganic acid. The salt can be sodium phosphate. The iron-based complex can include one or more components from the group consisting of iron carbonate, iron hydroxide and iron oxide. The components can be in particle form and the particles can be suspended in an organic solvent. The iron-based complex can include an oil soluble iron carboxylate.

In another aspect, a method for reducing hydrogen sulfide emissions from an asphalt composition is provided whereby an additive is mixed with the asphalt composition, the additive including a mixture of iron and copper complexes.

In another aspect, a method for reducing hydrogen sulfide emissions from an asphalt composition is provided whereby an additive is mixed with the asphalt composition, the additive including a mixture of iron, copper, and zinc complexes.

### BRIEF DESCRIPTION OF THE DRAWINGS

FIG. 1 is a line graph comparing H₂S reduction in asphalt before and after PPA addition for the presently disclosed additives and other additives in an illustrative embodiment.

FIG. 2 is a bar graph comparing percentages of scavenged H₂S before and after PPA addition for the presently disclosed additives and other additives in an illustrative embodiment.

While certain preferred illustrative embodiments will be described herein, it will be understood that this description is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

Disclosed herein are various illustrative embodiments of a method and composition for reducing hydrogen sulfide generated or emitted from an asphalt composition. For the purposes of this application, the term “asphalt” refers to any of a variety of materials that are solid or semisolid at 25° C. and which may gradually liquefy when heated, and in which the predominant constituents are naturally occurring bitumens (or kerogens) or which are bitumen like materials obtained as residues in, for example, petroleum refining. The asphalt may ultimately be used, for example, as paving and road-building materials or as roofing shingles.

Hydrogen sulfide may be present in asphalt as a naturally occurring material, especially in asphalts derived from kerogens. Oil which is heavily contaminated with sulfur, sometimes referred to in the art as sour crude, may also produce bottoms that have carried over hydrogen sulfide. Any asphalt which has a sulfur component may spontaneously emit hydrogen sulfide through a cracking process caused by heating the asphalt.

In certain illustrative embodiments, hydrogen sulfide present in asphalt is “scavenged” using a method including mixing an additive with the asphalt either prior to or concurrent with heating the asphalt. For the purposes of the present application, the term “scavenging” or the like means that an additive interacts with hydrogen sulfide in asphalt such that gaseous emissions of hydrogen sulfide from the asphalt are mitigated or eliminated.

In certain illustrative embodiments, the presently disclosed subject matter pertains to asphalt compositions containing asphalt modifiers such as polyphosphoric acid or “PPA.” PPA can refer specifically to polyphosphoric acid, or any other inorganic acid, including phosphoric acid, or phosphonate derivatives. This can also refer to salts of the inorganic acids, such as sodium phosphate or organic esters of said acids. PPA can cause certain hydrogen sulfide scavengers to lose their effectiveness and revert back to hydrogen sulfide after scavenging. Scavengers react chemically with hydrogen sulfide to produce a nonvolatile compound. In the case of zinc-based scavengers, they produce zinc sulfide. Under acidic conditions, zinc sulfide will react to produce H₂S. An example of the chemical process is as follows:

Zn(ligand)ₓ+x H₂S→ZnS+x H(ligand)

1/x ZnS+Hₓ(acid)→1/x H₂S+x acid⁻

Sources of H₂S in asphalt can be latent, or the H₂S can be produced from heavy aromatic sulfur asphaltenes via cracking, can be generated from added elemental sulfur, or can be regenerated when PPA (or other acids) are added to asphalt including scavenging products like zinc sulfide.

Disclosed herein are additives that act as scavengers and are resistant to the addition of the asphalt modifier to the asphalt. The scavenger can be added at any point in the asphalt production process to effectively reduce H₂S levels, including before or after addition of the asphalt modifier. In a preferred embodiment, the scavenger is added before the asphalt modifier. Further, the presence of other hydrogen sulfide scavenging additives, whether metal based or otherwise, does not reduce the effectiveness of the presently disclosed additives.

In addition to PPA, the presently disclosed subject matter is believed to be effective with other asphalt modifiers such as strong acids, mineral acids or organic acids used during asphalt manufacturing for the purpose of modifying asphalt properties.

In certain illustrative embodiments, a method is provided for reducing hydrogen sulfide emissions from an asphalt composition containing an asphalt modifier whereby an additive is mixed with the asphalt composition, the additive comprising a copper-based complex. As used herein, the term copper-based complex means any copper containing material. In one aspect, the copper-based complex can include one or more components from the group consisting of copper carbonate, copper hydroxide and copper oxide. These components can be in dispersed particle form. In another aspect, the copper-based complex can include copper carboxylate. The copper carboxylate can be an oil-soluble metal organic.

In another illustrative embodiment, a method is provided for reducing hydrogen sulfide emissions from an asphalt composition containing an asphalt modifier whereby an additive is admixed with the asphalt composition, the additive comprising an iron-based complex. As used herein, the term iron-based complex means any iron containing material. In one aspect, the iron-based complex can include one or more components from the group consisting of iron carbonate, iron hydroxide and iron oxide. These components can be in dispersed particle form. In another aspect, the iron-based complex can include iron carboxylate. The iron carboxylate can be an oil-soluble metal organic.

In certain illustrative embodiments, a composition is provided which includes asphalt and an additive wherein the additive comprises a copper-based complex. The composition can also include an asphalt modifier. The asphalt modifier can be polyphosphoric acid, in certain illustrative embodiments. In one aspect, the copper-based complex can include one or more components from the group consisting of copper carbonate, copper hydroxide and copper oxide. These components can be in dispersed particle form. In another aspect, the copper-based complex can include copper carboxylate.

In another illustrative embodiment, a composition is provided which includes asphalt and an additive wherein the additive comprises an iron-based complex. The composition can also comprise an asphalt modifier. The asphalt modifier can be polyphosphoric acid, in certain illustrative embodiments. In one aspect, the iron-based complex can include one or more components from the group consisting of iron carbonate, iron hydroxide and iron oxide. These components can be in dispersed particle form. In another aspect, the iron-based complex can include iron carboxylate.

In certain illustrative embodiments, the presently disclosed additive is a dispersion of particles within an organic solvent, for example, isoparaffinic solvents such as isopar M or L, using a dispersant chemical. In certain illustrative embodiments, the presently disclosed additive is an oil soluble complex and can be manufactured by dissolving a copper or iron oxide in an appropriate organic acid such as 2-ethylhexanoic acid (equivalent to octanoic acid), neodecanoic acid, isobutyric acid, naphthenic acid, or a mixture of the aforementioned acids (or other useful synthetic carboxylic acids), followed by dilution of the complex with an organic solvent, for example, isoparaffinic solvents such as isopar M or L. In any case, the additives can be applied to a stream of asphalt by conventional pump and injection methods which are well known to those skilled in the art. In certain illustrative embodiments, other metal based additives besides copper and iron may also be utilized, such as, without limitation, chromium.

In certain illustrative embodiments, active components of the oil soluble complexes can be copper (II) carboxylate, iron (II) carboxylate, or iron (III) carboxylate, where carboxylate can be any of the organic acids mentioned previously herein, or any combination thereof. The solvent used can consist of an aromatic solvent such as Exxon Aromatic 100 or 150, or isoparaffinic solvents such as Isopar M or L and a cosolvent consisting of glycol ether such as 2-butoxyethanol or glycol such as ethylene or propylene glycol. A typical formulation (by mass) is 50-80% metal carboxylate, 20-50% primary solvent and 1-5% cosolvent, in certain illustrative embodiments. For the dispersion type products, active components can be copper carbonate, hydroxide, or oxide; iron carbonate, hydroxide, or oxide in isoparaffinic solvent such as isopar M or L, in certain illustrative embodiments. Aromatics typically aren't used for dispersion type products. A typical formulation (by mass) is 30-70% metal particles, 40-60% solvent, and 1-10% dispersant, in certain illustrative embodiments.

In general, the presently disclosed additives may be introduced into the asphalt at any temperature or concentration useful to the intended end result. For example, the additive can be applied during production conditions, or when the asphalt is liquid. Without adequate asphalt fluidity, proper mixing of the active component of the scavenger into the asphalt is more difficult and there is substantially reduced contact between the additive and H₂S, so the additive would appear to be ineffective.

The presently disclosed additives can scavenge and retain H₂S under extreme conditions, which cause other traditional scavengers to revert the scavenged H₂S. For example, the presently disclosed additives are effective at temperatures in excess of 350° F.-400° F., and the high temperature conditions actually help the scavenging reaction proceed more quickly. The presently disclosed additives can do this less expensively than traditional organic-based scavengers. Many conventional organic-based scavengers will decompose at higher temperatures, thereby reducing effectiveness and cost efficiency.

In certain illustrative embodiments, other viable scavengers can also be added to the asphalt composition such as zinc carboxylates, zinc particulate dispersions, and amine aldehyde condensates. The asphalt composition may also contain other typical materials as would be known to those skilled in the art such as elemental sulfur (for improved asphalt properties) and polyisobutylene or other polymer modifying agents.

The presently disclosed additives scavenge latent and cracked H₂S and also prevent the regeneration of H₂S from scavenging products caused by the addition of PPA or other asphalt modifying agents. This differs from conventional additives (like, but not limited to zinc octoate) in that the asphalt is resistant to regeneration due to PPA addition. Notably, the prevention of PPA-based H₂S regeneration is not accomplished by deactivating PPA and thus at the expense of the quality of the resulting asphalt. Instead, PPA addition will still accomplish its desired asphalt modification in the presence of the presently disclosed additives.

In addition to asphalt compositions, the presently disclosed additives are also effective when used in asphalt-producing streams such as vacuum tower bottoms, vacuum gas oil, number 6 fuel oil and other hydrocarbon streams upstream of asphalt, in certain illustrative embodiments.

To facilitate a better understanding of the presently disclosed subject matter, the following examples of certain aspects of certain embodiments are given. In no way should the following examples be read to limit, or define, the scope of the presently disclosed subject matter.

### EXAMPLE 1

This first set of experiments was run in asphalt held at 300° F., and the testing was performed at a laboratory of one of Applicant's customers. The scavenging efficacy of several additives was tested at several dosages before and after polyphosphoric acid (PPA) was applied to the asphalt sample in question. The test results show that zinc octoate treatment loses effectiveness after PPA is added. The copper carbonate and organic imine additives maintain their effectiveness much better than zinc octoate. Very notably, the copper compound maintains greater than 90% of its scavenging efficacy at a 10:1 dose rate, which is a very common starting dose rate for industrial applications. Also importantly, a small dosage of the copper additive outperforms a much more concentrated dose of the zinc additive after PPA addition.

The results of the testing from Example 1 are shown in Table 1 and Table 2 below:

TABLE 1
H₂S Scavenging before PPA Addition

| | [H₂S], ppm | | | | % H₂S Reduction | | | |
|---|---|---|---|---|---|---|---|---|
| Product | 2:1 | 5:1 | 10:1 | 20:1 | 2:1 | 5:1 | 10:1 | 20:1 |
| Blank | 9,000 | | | | | | | |
| Organic Imine | 450 | 500 | 1,050 | 2,500 | 95.0% | 94.4% | 88.3% | 72% |
| Copper | 0 | 0 | 160 | 1,100 | 100.0% | 100.0% | 98.2% | 88% |
| Carbonate | | | | | | | | |
| Zinc Octoate | 0 | 0 | 0 | 1,000 | 100.0% | 100.0% | 100.0% | 89% |

TABLE 2
H₂S Scavenging after PPA Addition

| | [H₂S], ppm | | | | % H₂S Reduction | | | |
|---|---|---|---|---|---|---|---|---|
| Product | 2:1 | 5:1 | 10:1 | 20:1 | 2:1 | 5:1 | 10:1 | 20:1 |
| Blank | 9,000 | | | | | | | |
| Organic | 2,000 | 2,000 | 2,200 | 3,000 | 77.8% | 77.8% | 75.6% | 66.7% |
| Imine | | | | | | | | |
| Copper | 0 | 0 | 400 | 4,000 | 100.0% | 100.0% | 95.6% | 55.6% |
| Car- | | | | | | | | |
| bonate | | | | | | | | |
| Zinc | 3,500 | 8,000 | 9,000 | 9,000 | 61.1% | 11.1% | 0.0% | 0.0% |
| Octoate | | | | | | | | |

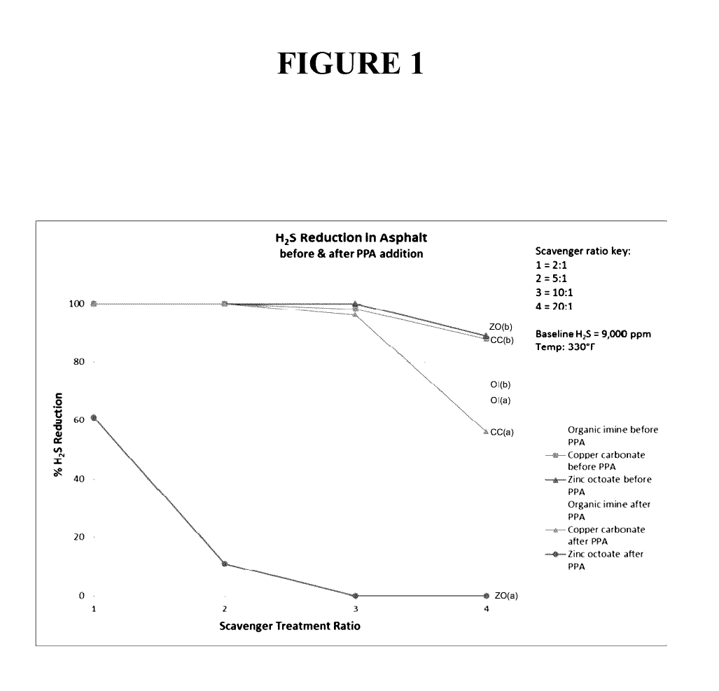

A line graph showing the results of the testing of Example 1 is shown in FIG. 1.

### EXAMPLE 2

This second set of experiments was run in Applicant's labs in Sugar Land, Tex. The solvent used was Isopar M™ fluid from ExxonMobile Chemical rather than asphalt, and the tests were run at a much lower temperature, in this case 140° F. Several copper-based additives were tested. Notably, a similar level of stability for the copper carbonate additive referred to in Example 1 was observed. In addition, an iron complex demonstrated good reversion resistance.

The results of the testing from Example 2 are shown in Table 3 below:

TABLE 3

| | | | | % |
|---|---|---|---|---|
| | Ppm H2S | % Scavenged | Ppm H2S | Scavenged |
| Time | Before PPA | | After PPA | |
| Blank | 8000 | | 5000 | |
| Copper Hydroxide | 2000 | 75 | 350 | 93 |
| 10:1 | | | | |
| Copper Hydroxide | 6000 | 25 | 5000 | 0 |
| 20:1 | | | | |
| Copper Octoate 10:1 | 5000 | 38 | 300 | 94 |
| Copper Octoate 20:1 | 8000 | 0 | 5000 | 0 |
| Copper Carbonate | 500 | 94 | 0 | 100 |
| 10:1 | | | | |
| Copper Carbonate | 2000 | 75 | 200 | 96 |
| 20:1 | | | | |
| Organic Imine 10:1 | 50 | 99 | 0 | 100 |
| Organic Imine 20:1 | 300 | 96 | 0 | 100 |
| Iron Octoate 10:1 | 0 | 100 | 0 | 100 |
| Iron Octoate 20:1 | 100 | 99 | 0 | 100 |

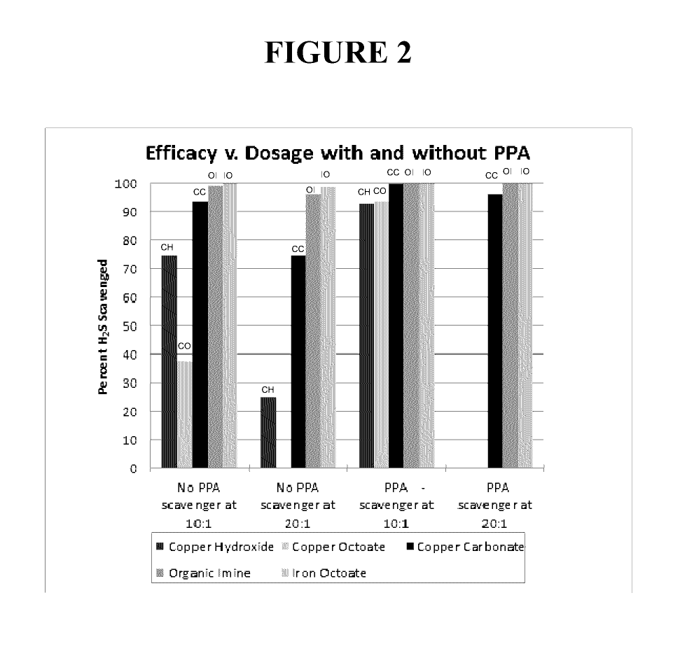

A bar graph showing the results of the testing of Example 2 is shown in FIG. 2.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

1. A method for reducing hydrogen sulfide emissions from an asphalt composition, the method comprising:
mixing an additive with the asphalt composition wherein the additive comprises a copper-based complex.

2. The method of claim 1, wherein the asphalt composition comprises asphalt and an asphalt modifying acid.

3. The method of claim 2, wherein the hydrogen sulfide is one or more of latent hydrogen sulfide, hydrogen sulfide produced by cracking and hydrogen sulfide produced by regenerative processes caused by the asphalt modifying agent being added to the asphalt composition.

4. The method of claim 2, wherein the asphalt modifying acid is polyphosphoric acid.

5. The method of claim 2, wherein the asphalt modifying acid is an inorganic acid.

6. The method of claim 5, wherein the inorganic acid is phosphoric acid or a phosphonate derivative.

7. The method of claim 2, wherein the asphalt modifying acid is a salt or organic ester of an inorganic acid.

8. The method of claim 7, wherein the salt is sodium phosphate.

9. The method of claim 1, wherein the copper-based complex comprises one or more components from the group consisting of copper carbonate, copper hydroxide and copper oxide.

10. The method of claim 1, wherein the copper-based complex comprises copper carboxylate.

11. The method of claim 10, wherein the copper carboxylate is an oil-soluble metal organic.

12. The method of claim 1, wherein the copper-based complex is formed by reacting copper with an organic acid and diluting the resultant mixture with an organic solvent.

13. A method for reducing hydrogen sulfide emissions from an asphalt composition, the method comprising:
mixing an additive with the asphalt composition wherein the additive comprises an iron-based complex.

14. The method of claim 13, wherein the iron-based complex comprises one or more components from the group consisting of iron carbonate, iron hydroxide and iron oxide.

15. The method of claim 13, wherein the iron-based complex comprises iron carboxylate.

16. The method of claim 15, wherein the iron carboxylate is an oil-soluble metal organic.

17. A composition comprising an asphalt and an additive wherein the additive comprises a copper-based complex.

18. The composition of claim 17, wherein the copper -based complex comprises one or more components from the group consisting of copper carbonate, copper hydroxide and copper oxide.

19. The composition of claim 17, wherein the copper-based complex comprises an oil soluble copper carboxylate.

20. A composition comprising an asphalt and an additive wherein the additive comprises a iron-based complex.

21. The composition of claim 20, wherein the iron-based complex comprises one or more components from the group consisting of iron carbonate, iron hydroxide and iron oxide.

22. The composition of claim 20, wherein the iron-based complex comprises an oil soluble iron carboxylate.

23. A method for reducing hydrogen sulfide emissions from an asphalt composition, the method comprising: mixing an additive with the asphalt composition wherein the additive comprises a mixture of iron and copper complexes.
